(19) United States
(12) Patent Application Publication
(10) Pub. No.: US 2025/0086218 A1
(43) Pub. Date: Mar. 13, 2025

(54) COGNITIVE CATEGORIZATION AND ANALYSIS OF DATA SAMPLES

(71) Applicant: International Business Machines Corporation, Armonk, NY (US)

(72) Inventors: Natalia Russi-Vigoya, Round Rock, TX (US); Jennifer M. Hatfield, Portland, OR (US); Christopher F. Ackermann, Fairfax, VA (US); Jeremy R. Fox, Georgetown, TX (US)

(21) Appl. No.: 18/367,972

(22) Filed: Sep. 13, 2023

(51) Int. Cl. G06F 16/34; G06F 16/35; G06F 16/38

(52) U.S. Cl. CPC G06F 16/345; G06F 16/353; G06F 16/38

(57) ABSTRACT

A computer-implemented method, according to one embodiment, includes: receiving data and predetermined tags associated with the received data. Content in the received data is summarized, and a machine learning model is used to analyze the summarized content as well as the received data. The received data is divided into clusters of information, and tags are generated for the clusters of information by merging (i) the predetermined tags, and (ii) details produced by the machine learning model. The generated tags are also output.

### BACKGROUND

The present invention relates to data analysis, and more specifically, this invention relates to dynamically achieving cognitive categorization and analysis of data samples.

Data production continues to increase as computing power advances. For instance, the rise of smart enterprise endpoints has led to large amounts of data being generated at remote locations. Data production will only further increase with the growth of 5G networks and an increased number of connected mobile devices. Increased data production has also become more prevalent as the complexity of machine learning models increase. Increasingly complex machine learning models translate to more intense workloads and increased strain associated with applying the models to received data.

As data production increases, so does overhead associated with processing the data. This is particularly true for unstructured data which is not analyzed using conventional data tools and methods. For instance, unstructured data is not formatted. While unformatted data is more versatile in terms of how it is evaluated, the process of analyzing the data is complicated and cumbersome. Moreover, specialized tools are used to manipulate the unstructured data.

Different types of information may also be included in the unstructured data. For example, video and audio data may be combined in a pool of unstructured data. However, different types of information are processed using different procedures. The process of evaluating unstructured data is thereby further complicated in situations involving unstructured data that includes more than one type of information.

### SUMMARY

A computer-implemented method, according to one embodiment, includes: receiving data and predetermined tags associated with the received data. Content in the received data is summarized, and a machine learning model is used to analyze the summarized content as well as the received data. The received data is divided into clusters of information, and tags are generated for the clusters of information by merging (i) the predetermined tags, and (ii) details produced by the machine learning model. The generated tags are also output.

A computer program product, according to another embodiment, includes a computer readable storage medium having program instructions embodied therewith. The program instructions are readable by a processor, executable by the processor, or readable and executable by the processor, to cause the processor to: perform the foregoing method.

A system, according to yet another embodiment, includes: a processor, and logic that is integrated with the processor, executable by the processor, or integrated with and executable by the processor. Moreover, the logic is configured to: perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of a procedure, in accordance with one approach.

FIG. 3C is a flowchart of sub-processes for one of the operations in the method of FIG. 3A, in accordance with one approach.

FIG. 4 is a partial representational flowchart of a method, in accordance with one approach.

FIG. 5 is a flowchart of a method, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for analyzing source data as well as dynamically generate clusters and corresponding tags to support cognitive categorization and analysis of the source data. For instance, trained machine learning models may be used to identify trends and/or common patterns in the source data and develop corresponding tags. These identified trends and/or patterns may further be used to organize and/or structure the source data as desired, e.g., as will be described in further detail below.

In one general approach, a computer-implemented method includes: receiving data and predetermined tags associated with the received data. Content in the received data is summarized, and a machine learning model is used to analyze the summarized content as well as the received data. The received data is divided into clusters of information, and tags are generated for the clusters of information by merging (i) the predetermined tags, and (ii) details produced by the machine learning model. The generated tags are also output.

In another general approach, a computer program product includes a computer readable storage medium having program instructions embodied therewith. The program instructions are readable by a processor, executable by the processor, or readable and executable by the processor, to cause the processor to: perform the foregoing method.

In yet another general approach, a system includes: a processor, and logic that is integrated with the processor, executable by the processor, or integrated with and executable by the processor. Moreover, the logic is configured to: perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved tag generation code at block 150 for analyzing source data as well as dynamically generate clusters and corresponding tags to support cognitive categorization and analysis of the source data. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

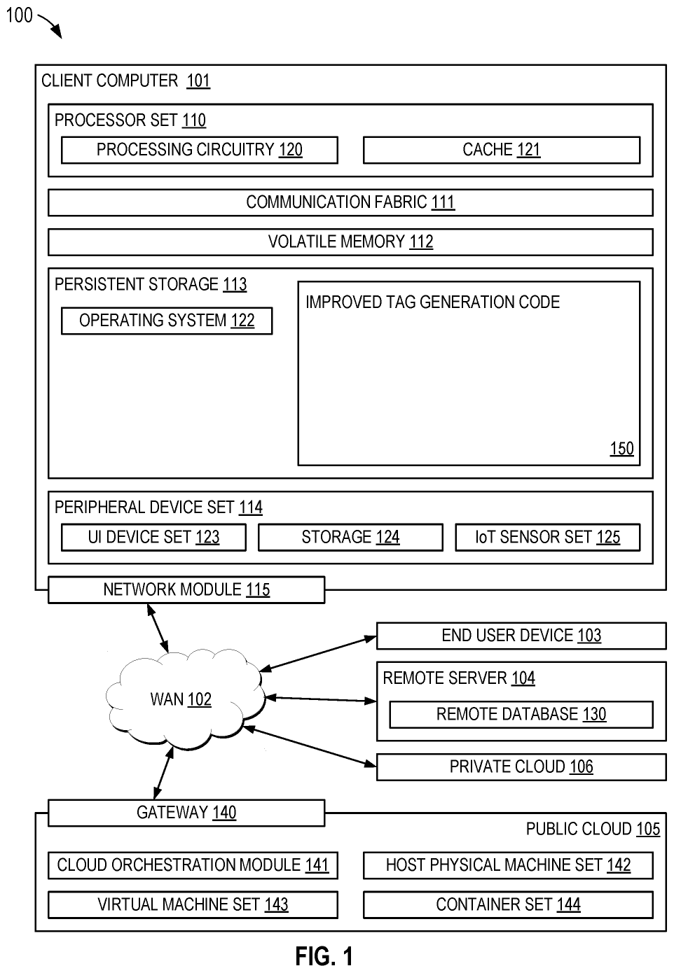

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various implementations.

As noted above, data production continues to increase as computing power advances. For instance, the rise of smart enterprise endpoints has led to large amounts of data being generated at remote locations. Data production will only further increase with the growth of 5G networks and an increased number of connected mobile devices. Increased data production has also become more prevalent as the complexity of machine learning models increase. Increasingly complex machine learning models translate to more intense workloads and increased strain associated with applying the models to received data.

As data production increases, so does the overhead associated with processing the data. This is particularly true for unstructured data which is not analyzed using conventional data tools and methods. For instance, unstructured data is not formatted. While unformatted data is more versatile in terms of how it is evaluated, the process of analyzing the data is complicated and cumbersome. Moreover, specialized tools are used to manipulate the unstructured data.

Different types of information may also be included in the unstructured data. For example, video and audio data may be combined in a pool of unstructured data. However, different types of information are processed using different procedures. The process of evaluating unstructured data is thereby further complicated in situations involving unstructured data that includes more than one type of information.

These difficulties associated with processing unstructured data have caused conventional products to be negatively impacted. However, in sharp contrast to these conventional shortcomings, implementations herein are able to efficiently and dynamically analyze source data and generate tagged clusters which cognitively categorize the source data. For instance, trained machine learning models may be used to identify trends and/or common patterns in the source data and develop corresponding tags. These identified trends and/or patterns may further be used to organize and/or structure the source data as desired, e.g., as will be described in further detail below.

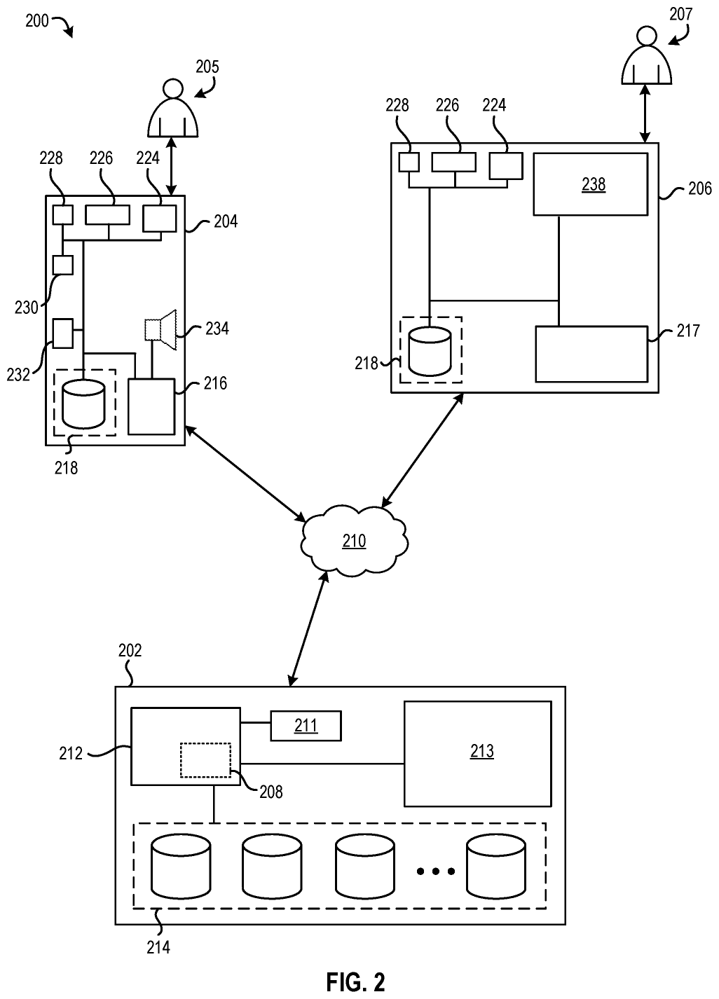

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc.; etc., or any other type of connection which would be apparent to one skilled in the art after reading the present description. The terms “user” and “administrator” are in no way intended to be limiting either. For instance, while users and administrators may be described as being individuals in various implementations herein, a user and/or an administrator may be an application, an organization, a preset process, etc. The use of “data” and “information” herein is in no way intended to be limiting either, and may include any desired type of details, e.g., depending on the type of operating system implemented on the user device 204, edge node 206, and/or central server 202.

With continued reference to FIG. 2, the central server 202 includes a large (e.g., robust) processor 212 coupled to a cache 211, a machine learning module 213, and a data storage array 214 having a relatively high storage capacity. The machine learning module 213 may include any desired number and/or type of machine learning models. In preferred approaches, the machine learning module 213 includes machine learning models that have been trained to analyze source data as well as dynamically generate clusters and corresponding tags to support cognitive categorization and analysis of the source data. With respect to the present description, a data cluster includes a collection of data, each of which are related to each other and have been organized together.

As noted above, analyzing unstructured data is a difficult and taxing process, even in situations where specialized tools are available. As a result, conventional products have been unable to provide reliable analysis of unstructured data. In contrast, machine learning module 213 and/or processor 212 may be able to analyze unstructured data and generate tagged clusters which cognitively categorize the source data. For instance, the machine learning module 213 may include machine learning models that are trained to identify trends and/or common patterns in the source data and develop corresponding tags. These identified trends and/or patterns may further be used to organize and/or structure the source data as desired.

It follows that generating tags for each of the clusters allows users to structure data according to themes and makes the data searchable. Different types of tags may also be used to identify specific portions of the data. For instance, workflow tags, journey tags, sentiment tags, general tags, etc., or any other desired type of tag may be used to characterize the different clusters that are formed. In some approaches, predetermined tags may be established by users, e.g., based on anticipated workloads, user preferences, types of data being received, etc. In other approaches, inductive tags may be generated dynamically based on the data that is received.

The machine learning models may further be configured to modify the clusters and/or tags, before converting at least a copy of the modified tags into a predetermined exportable format, e.g., such as any desired format (e.g., .pdf, .csv, etc.), style, language, etc. Accordingly, the machine learning module 213 may be used to evaluate and categorize sets of data received from the user device 204 and/or edge node 206, e.g., as would be appreciated by one skilled in the art after reading the present description.

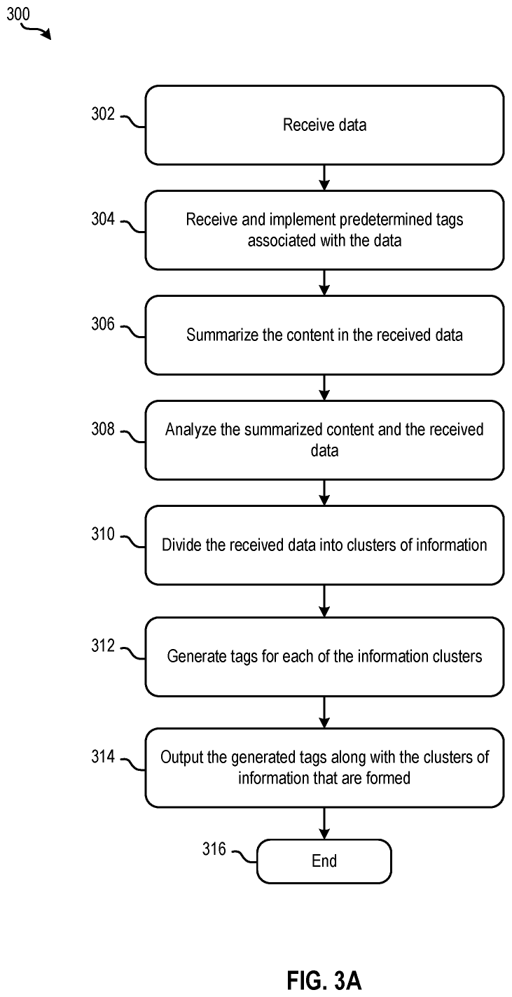

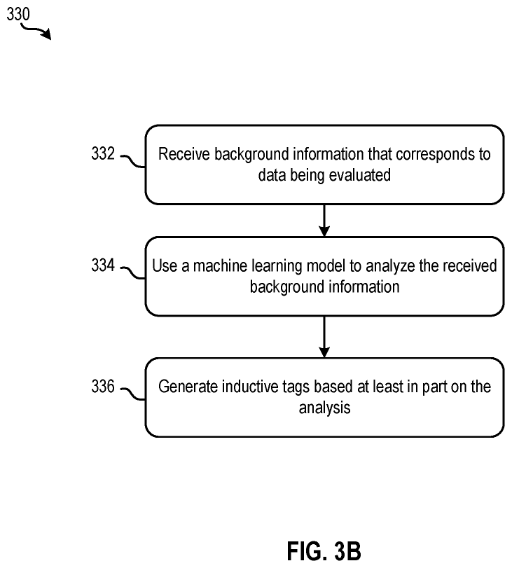

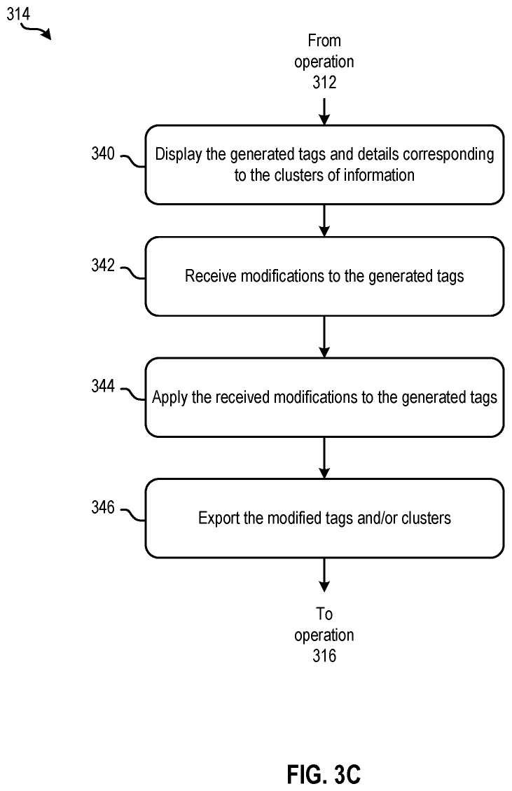

The processor 212 is also shown as including a content clarifier module 208 configured to evaluate the received data and dynamically simplify the content in the received data. In other words, the content clarifier module 208 may be used to evaluate the content of the received data and generate a simplified summary or meaning. The content clarifier module 208 may thereby be used to identify central (e.g., important) aspects of the data and separate the data into clusters of information which correspond to these central aspects. It follows that in some approaches, content clarifier module 208 may be used in combination with performing one or more of the operations included in method 300 of FIG. 3A below.

With continued reference to FIG. 2, it follows that the content clarifier module 208 can monitor data as it is received at the central server 202, e.g., from user device 204 and/or edge node 206. Looking to user device 204, a processor 216 coupled to memory 218 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Some data may be received from user 205 for storage and/or evaluation using machine learning module 213. The data may be received as a result of the user 205 using one or more applications, software programs, temporary communication connections, etc. running on the user device 204. For example, the user 205 may upload data for storage at the data storage array 214 and evaluation using processor 212 and/or machine learning module 213 of central server 202. As a result, the data is evaluated and clusters of information, as well as corresponding tags, are generated. The clusters and tags that are generated may be displayed (e.g., presented) to the user 205 at the user device 204 for review. The user 205 may modify the generated clusters and/or tags as desired before being returned to the central server 202 for implementation. As a result, clusters and corresponding tags that achieve cognitive categorization and analysis of the data originally provided by user 205 may be returned from central server 202. In some implementations, the clusters and corresponding tags may be evaluated further and/or used to train machine learning models and improve their ability to accurately evaluate and generate data, e.g., using one or more of the operations in method 300 of FIG. 3A, below.

Looking to the edge node 206 of FIG. 2, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to a machine learning module 238. As described above with respect to machine learning module 213, the machine learning module 238 may include any desired number and/or type of machine learning models. In preferred approaches, the machine learning module 238 includes machine learning models that have been trained to analyze source data as well as dynamically generate clusters and corresponding tags to support cognitive categorization and analysis of the source data. The machine learning models may further be configured to convert the information in any desired format, style, language, etc., for the given implementation.

Accordingly, the machine learning module 238 may evaluate data produced and/or stored at the edge node 206, locally analyze that data, and locally generate clusters and corresponding tags. The machine learning module 238 may thereby be able to perform substantial evaluation of sets of data without sending any information over a network. In some approaches, security measures may be lowered for prompts being processed locally by machine learning module 238 and returned directly to administrator 207. For example, certain data may be provided to machine learning module 238 and analyzed locally, while that same data may be denied from being sent to machine learning module 213 over network 210 according to compliance metrics. Additionally, because the machine learning module 238 is included at the edge node 206, responses may be generated even when the connection to network 210 is lost. In still other approaches, the machine learning module 238 may coordinate with machine learning module 213 to evaluate different sets of data received from user 205 and/or administrator 207 in parallel, e.g., as would be appreciated by one skilled in the art after reading the present description.

However, in sharp contrast to these conventional shortcomings, implementations herein are able to efficiently and dynamically analyze source data and generate tagged clusters which cognitively categorize the source data. For instance, trained machine learning models may be used to identify trends and/or common patterns in the source data and develop corresponding tags. These identified trends and/or patterns may further be used to organize and/or structure the source data as desired, e.g., as will be described in further detail below.

Looking now to FIG. 3A, a flowchart of a computer-implemented method 300 for dynamically analyzing source data and generating tagged clusters which cognitively categorize the source data, is illustrated in accordance with one approach. In other words, method 300 may be performed to identify trends and/or common patterns in the source data and develop corresponding tags. These identified trends and/or patterns may further be used to organize and structure the source data as desired. Method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For example, one or more processors located at a central server of a distributed system (e.g., see processor 212 of FIG. 2 above) may be used to perform one or more of the operations in method 300. In another example, one or more processors are located at an edge server (e.g., see controller 217 of FIG. 2 above).

Moreover, in various approaches, the method 300 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 302 includes receiving data to be analyzed and tagged. In other words, the data may be received with one or more instructions (e.g., requests) to process the data. Typically, the data that is received is unstructured data. As alluded to above, one of the key advantages of unstructured data is that it helps provide qualitative information that is useful for understanding trends and changes in the data. However, the process of evaluating the unstructured data to determine these trends and changes has been taxing and caused performance setbacks in conventional products. Implementations herein are able to overcome these conventional performance issues by training one or more machine learning models to evaluate unstructured data as it is received in real-time and dynamically develop tagged clusters of the unstructured data, e.g., as will be described in further detail below.

The type, format, and/or amount of data received in operation 302 may also vary depending on the implementation. As noted above, unstructured data is an amalgamation of data typically stored in data lakes. This collection of data may include unstructured data that corresponds to various types of information, e.g., such as social media posts, video recordings, text files, audio signals (e.g., recordings), screen grab recordings, etc. In other words, the unstructured data may be collected (e.g., extracted) from different sources.

In addition to receiving the data to be evaluated, predetermined tags that are associated with the data may also be received and implemented. See operation 304. The predetermined tags may be established using information known about unstructured data being evaluated. According to an example, which is in no way intended to be limiting, a researcher that generated a sample set of unstructured data may create predetermined tags to be applied while analyzing the data. The researcher is also able to customize details of the predetermined tags based on the particular implementation. These predetermined tags may thereby be created based on the testing conditions used to generate the data, the types of information included in the unstructured data, preferences of the user (e.g., a desired extraction format), etc.

The predetermined tags may thereby be received from a same source as the data being evaluated. In some approaches, the predetermined tags are received in parallel with the data they correspond to. In other approaches, the predetermined tags may be received and incorporated into the machine learning models before the corresponding data is received and/or evaluated. Unstructured data may thereby be evaluated using machine learning models that have already been trained to identify specific tags. It follows that the predetermined tags are preferably stored and implemented while generating tags for at least corresponding ones of received data sets.

Additional information may also be received and used during the process of evaluating the data. In some approaches, background information corresponding to the data is received. In other words, details that describe certain characteristics of the data may be received in addition to the predetermined tags. According to another example, which again is in no way intended to limit the invention, a research plan that includes details describing how the received data was generated may be obtained. In other words, information in the research plan may outline research objectives, research question(s), research methods, data collection methods, participants, and any other relevant information about the research study. This background information thereby provides useful insight into the received data and can be used to gain a better understanding of the received data itself.

Referring momentarily to FIG. 3B, exemplary operations of a procedure 330 are illustrated in accordance with one embodiment. One or more of the operations in procedure 330 may be performed in coordination with at least operations 302, 304, 306 of FIG. 3A. In other words, procedure 330 may be performed in the background (e.g., in response to receiving background information) without impacting the performance of method 300. However, it should be noted that the operations of FIG. 3B are illustrated in accordance with one embodiment which is in no way intended to limit the invention.

As shown, optional operation 332 includes receiving background information that corresponds to data being evaluated. With respect to the present description, operation 332 is “optional” in the sense that background information corresponding to data being analyzed is not always available. Thus, operation 332 is performed in response to situations where background information is received.

As noted above, details like background information may be received along with the data being evaluated and/or any predetermined tags in some approaches. In other approaches background information may be received separate from the data being evaluated. In some approaches, the background information is received while the data is being generated, e.g., such that the background information may be evaluated and/or machine learning models may be trained before the data being evaluated is received.

According to one example, supplemental notes taken while data is generated may be evaluated to generate details corresponding to the data. This background information provides useful insight into the received data and can be used to gain a better understanding of the received data itself. Accordingly, operation 334 includes using a machine learning model to analyze the received background information, while operation 336 includes generating inductive tags based at least in part on the analysis. In other words, operation 334 and 336 evaluate the content of the background information to dynamically identify inductive tags that may be used to identify (e.g., explain) trends in the data as it is received and processed.

Returning now to FIG. 3A, method 300 proceeds from operation 304 to operation 306. There, operation 306 includes summarizing the content in the received data. In other words, the content in the received data is evaluated and used to generate a simplified summary of the content therein. In some approaches, the received data is evaluated using a content clarifier module (e.g., see content clarifier module 208 of FIG. 2 above). For instance, content in the received data may be summarized by sending one or more instructions to a content clarifier module to evaluate the received data and dynamically simplify the content in the received data. Moreover, summarized content may be received in return from the content clarifier module.

One or more machine learning models may be used to evaluate the data and generate the summarized content. According to one example, which is again in no way intended to be limiting, machine learning models can apply natural language processing (NLP) to data that includes text. According to another example, machine learning models may be configured to perform classification based machine learning on received data. As a result, the machine learning models may be able to develop an understanding of the content in the data, and generate a summarized version (e.g., copy).

Proceeding to operation 308, machine learning models are used to analyze the summarized content and the received data. In other words, machine learning models are used to evaluate the summarized content in comparison to the complete data that was received. In at least some approaches, operation 308 includes sending one or more instructions to a machine learning module, the instructions causing the machine learning module to evaluate the summarized content and the received data.

In response to the summarized content and the received data being analyzed, the machine learning models are preferably able to provide information (e.g., outputs) which can be used to divide the received data into clusters of information. Accordingly, operation 310 includes dividing the received data into clusters of information. Again, these clusters of information are formed based on the evaluation of the data and the data summary.

The machine learning models are also preferably able to generate tags for each of the information clusters. See operation 312. As noted above, the tags may be generated by merging different types of information. For instance, tags may be generated for each cluster of information by merging any predetermined tags with any inductive tags. Moreover, the predetermined and/or inductive tags may be compared against any information produced by the machine learning models for each respective cluster of information as a result of analysis thereof.

According to some approaches, operation 312 includes automatically identifying different types of tags from data and related artifacts from user research sessions. As noted above, the tags may be generated using machine learning models that are configured using a set of rules and trained using a set of annotated ground truth data. Moreover, signal extraction is performed to collection the raw data that represents the basis for both creating ground truth, and the eventual detection of tags.

Ground truth creation involves annotating a set of sample data to teach machine learning models to identify a specific tag to apply to a given cluster of information. Moreover, the machine learning models may be trained over time using results of past performance. A set of features are preferably extracted from the raw data originally received and used to generate the tags. For instance, the extracted features may assist one or more machine learning models in effectively evaluating raw (e.g., unstructured) data.

Machine learning models trained to generate tags for data being analyzed may leverage a rich set of input signals that are collected. A rich set of sensory input signals is desirable by allowing for confident and reliable judgements to be made. As noted above, machine learning models may apply NLP, classification based machine learning, etc. to the received data. As a result, the machine learning models may be able to develop an understanding of the content in the data, and generate a summarized version (e.g., copy).

According to an in-use example, activity performed by a user is captured using a video camera focused on the user as well as a screen of the user's computer. From such a recording, a set of high-level signals are derived. Looking to the video recordings, the video of the user provides insight into their emotional state (e.g., confusion, excitement, etc.) at different points in time. Similarly, any audio signals captured may be used to determine an emotional state of the user, capturing details from the user, e.g., such as exasperation, surprise, etc. The user may also describe details of a corresponding task which may be used to develop journey tasks. Furthermore, any recordings of the user's screen may be used to tag different steps a user performs along their journey.

While this base data is rich in content, the data is often too noisy to feed into a tagging algorithm and generate reliable tags. Hence, features are extracted from the data that focus on specific aspects of the desired content (e.g., the signal) while ignoring remaining information (e.g., ignoring noise).

According to another example, video data (e.g., recordings) may display a user's face, and thereby can reveal emotions about the user, e.g., such as surprise or confusion. Accordingly, emotion may be extracted from facial expressions identified in video data. The emotions that are detected throughout a user session are extracted and used as an input signal for the tagging algorithm. Similar to facial expression, the inflection of a user's voice may be important in determining sentiment tagging. In addition, it may be used to identify tags that go beyond the typical sentiment categories and generate tags, such as “frustration”, “excitement”, etc. In some approaches, a transcript outlining the words expressed by a user can be used to inform sentiment tagging, journey tagging, difficulty, etc. Text recognition, e.g., such as an existing OCR engine, may be used to extract the text from images captured.

The signals that are captured through the different types of media are input into one or more machine learning models that are trained to correlate these inputs to one or more tags. The inputs are divided into equally sized sections, such that there are “n” number of sections of a specific length. Each section contains the features that were extracted from the video, audio, and screen raw signal during that specific section. The machine learning algorithm makes predictions for each of those sections given the respective features.

Each of the different types of tags will be predicted by a different machine learning model. That is, one model will be trained to predict workflow tags, another predicts journey tags, etc. Different types of tags may be used to provide further granularity while identifying transitions in the data, these transitions corresponding to the workflow, types of workflows, user reactions, etc. It follows that the types of tags that are generated for the information clusters may differ depending on the implementation. For instance, the generated tags may include journey tags, workflow tags, sentiment tags, general tags, etc.

With respect to the present description, journey tags may be used to provide information about the location of a respondent along the path of completing a task. In other words, journey tags may indicate which stage of completing the task the received data corresponds to. In some approaches, journey tags may be used identify common paths or deviations in data and develop an overall understanding of the data. For example, before a study is conducted, a researcher may predefine the steps along a path of completing a task, and tags can be generated for each of the predefined steps accordingly. This allows the journey tags to indicate the overall journey of completing the task, and provide a more comprehensive picture of the user experience. For example, the journey steps predetermined for a given cloud pack for data deployment may include: discovery, evaluation, engaging, deployment, production and build out, maintain, monitor, and expand.

In some approaches, a journey may include several workflows. As mentioned above, a recording may be captured for each execution of each workflow. Journey tags may thereby be used to identify what workflow within a journey is captured by a specific recording. In some situations, a workflow may be identified by leveraging the workflow tags. More specifically, workflow tags already identify the phases in the workflow. It follows that before data is generated, users (e.g., researchers) may specify what workflow tags are associated with each journey, as well as the order these workflow phases occur. A workflow may thereby be categorized by assessing the similarity of the captured workflow tags for a user session to predefined (e.g., predetermined) tags mapped by the users. Such a workflow phase sequence similarity may be calculated using a simple edit distance calculation.

It follows that “workflow tags” are tags that help with task management. For instance, a researcher may want to know the specific moment when a participant was able to define a profile, complete a purchase, or find a product. Workflow tags are able to align this task with other performance metrics, e.g., such as time on task and task completion. A workflow may be captured in one user session which is recorded for analysis. Workflow tags are thereby used to define the transition of phases in the workflow and the model used for predicting such tags will be hybrid in nature. In other words, the workflow tags may be generated using rule based and statistical components. The statistical components may be used to recognize general expressions associated with completing a task by analyzing information such as the transcript of words spoken by a user. Machine learning models may thereby be trained to recognize expressions that are correlated with certain phases of the workflow. For example, a phrase similar to “Okay, I'm done” may be interpreted as indicating the workflow has completed. Moreover, this correlation may be common across different types of data. Therefore, the statistical model component can be reused over many user sessions.

Text that is accessible to and/or directly used by users may also be used to generate workflow tags. For example, text displayed on a screen visible to a user may be used to generate workflow tags. More specifically, key words in the displayed text may be used to identify that the user is at a transition point of the workflow (e.g., either the end of a section or the beginning of a new section). A dictionary may thereby be created that lists the extracted keywords that represent a point of transition in the workflow. The dictionary may also capture the corresponding phase of the workflow the user is in. Because every project is different, a dictionary is created at the beginning of the research project, but can be used throughout all user sessions conducted for that project. Given these inputs, machine learning models may be trained to predict transitions in the workflow and the specific phase of the workflow, e.g., as would be appreciated by one skilled in the art after reading the present description.

In still other approaches, sentiment tags may be generated. Sentiment tags may be used to indicate the status of a given user (e.g., participant). For instance, an intelligent system may be able to identify sections with sentiment statements and indicate the time and duration of the experience. According to an example, machine learning models may be able to evaluate data and determine if the corresponding user is experiencing a positive, negative, happy, surprised, angry, etc. scenario in response to completing or attempting to complete a task.

Sentiment serves as an important piece of information that helps identify problems in workflows. In some approaches, sentiment is identified by reviewing any user session recordings and tags are associated with the times in the recording. Moreover, two or more different types of signals are used to more easily (e.g., automatically) identify sentiment. For instance, comparing facial expressions and the voice of a user may provide supplemental information. The facial expressions a user has as they traverse a workflow can be a telling sign about the data and how it is being interpreted. Accordingly, some approaches generate sentiment tags whenever a sentiment model yields an output during a user session. Thus, sentiment tags may be formed by taking the sum of all other sentiments that have been generated.

With continued reference to FIG. 3A, method 300 advances to operation 314 from operation 312. There, operation 314 includes outputting the generated tags along with the clusters of information that are formed. As noted above, these generated clusters and corresponding tags support the cognitive categorization and analysis of source data being evaluated. Accordingly, the process of outputting the generated tags and clusters of information may involve modifying the evaluated data before being stored in memory. In other approaches, the generated clusters and corresponding tags may be output to an original source of the data. Accordingly, the machine learning models that generated the clusters and/or tags may further be configured to convert this information in any desired format, style, language, etc., for the particular implementation.

Referring momentarily now to FIG. 3C, exemplary sub-operations of outputting generated clusters and the corresponding tags, are illustrated in accordance with one embodiment. It follows that one or more of the sub-operations in FIG. 3C may be used to perform operation 314 of FIG. 3A. However, it should be noted that the sub-operations of FIG. 3C are illustrated in accordance with one embodiment which is in no way intended to limit the invention.

As shown, sub-operation 340 includes displaying the generated tags and details corresponding to the clusters of information. In some approaches, the tags and clusters may be displayed to a source of the data that was evaluated to generate the tags and clusters. For example, the generated tags and clusters of information may be returned to a user device over a network for evaluation (e.g., see user device 204 and network 210 of FIG. 2).

From sub-operation 340, the flowchart advances to sub-operation 342. There, sub-operation 342 includes receiving modifications to the generated tags from the user. Moreover, sub-operation 344 includes applying the received modifications to the generated tags. The number and/or type of modifications that are received depends on the user, how well machine learning models evaluated the source data to generate the tags and clusters, a rate at which data is being changed, etc. In some approaches, received modifications may be stored in a queue and performed in a same order as they were received. In other approaches, redundant modifications may be deduplicated before being used to alter the tags and/or clusters of information. This desirably reduces performance overhead while also lowering data errors resulting from invalid (e.g., outdated) data.

In still other approaches, the modifications received from users may be evaluated before being implemented. For example, one or more machine learning models may be used to analyze the modifications that are submitted by users and identify potential issues. Modifications identified as likely causing issues with how the data is interpreted, thereby potentially leading to failed analysis, may be denied. In some implementations, failed modifications may be returned to a user for adjustment and resubmission.

In response to implementing at least some of the modifications originally received in sub-operation 342, the modified tags and/or clusters may be exported. See sub-operation 346. In other words, sub-operation 346 includes providing the resulting tags and clusters of information to a target location. According to some approaches, the modified tags and clusters may be exported (e.g., sent) to a source that originally sent the data that was evaluated to generate the original tags and clusters. The modified tags and clusters may thereby be used to perform additional processing that is able to analyze the data more efficiently due to the generated tags and clusters, e.g., as would be appreciated by one skilled in the art after reading the present description.

Furthermore, the modified tags and clusters may be sent to a target location in any desired exportable format. For example, the modified tags and clusters may be converted (e.g., translated) into a predetermined exportable format before being sent to a target location. The predetermined exportable format may correspond to an operating system implemented at the target location, types of additional analysis planned to be performed on the data using the modified tags and clusters, etc. According to some approaches, the modified tags and clusters may be converted into one or more .pdf, .csv, .docx, etc. files. The converted modified tags and cluster may thereby be sent to the target location.

Returning to FIG. 3A, from operation 314 the flowchart proceeds to operation 316, whereby method 300 may end. However, it should be noted that although method 300 may end upon reaching operation 316, any one or more of the processes included in method 300 may be repeated in order to analyze additional sets of data received. In other words, any one or more of the processes included in method 300 may be repeated for subsequently received sets of data (e.g., unstructured data).

Again, method 300 is able to dynamically analyze source data and generate tagged clusters which cognitively categorize the source data. In other words, method 300 can be performed to identify trends and/or common patterns in source data and develop corresponding tags that provide additional insight to the data. These identified trends and/or patterns may further be used to organize and structure the source data as desired, causing the source data to be processed (e.g., analyzed) efficiently, particularly in comparison to the shortcomings of conventional products.

Some implementations involve storing information (e.g., tags, machine learning models, clusters, etc.) on private clouds. Accordingly, this generated information may be used in multiple devices and in a collaborative manner. It follows that multiple users (e.g., researchers) may be able to add tags and other notes in real-time as data is processed, as well as after that point. In some approaches, recommendations may be provided based on a type of user research methodology. These recommendations may be generated as a result of understanding the capabilities of different systems and provide recommendations that improve performance.

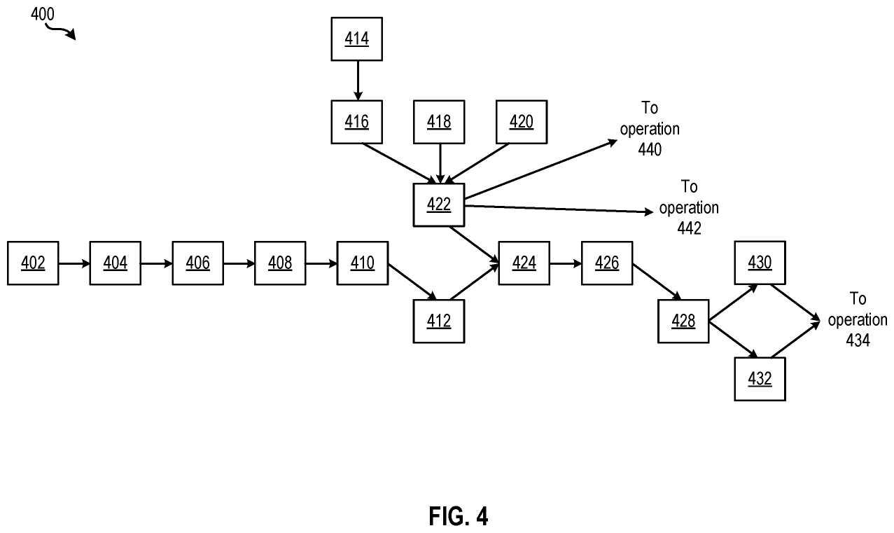

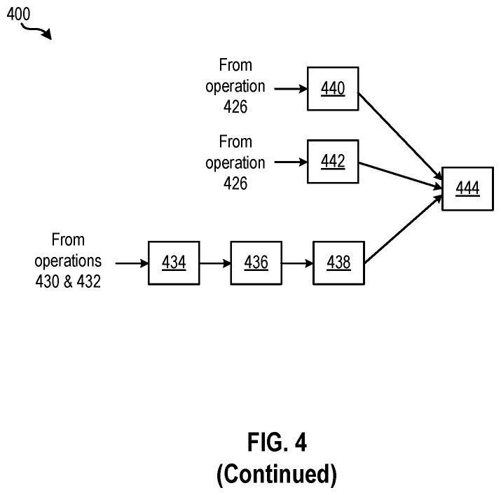

Referring now to FIG. 4, a flowchart of a computer-implemented method 400 for dynamically analyzing source data and generating tagged clusters which cognitively categorize the source data, is illustrated in accordance with one approach. In other words, method 400 may be performed to identify trends and/or common patterns in the source data and develop corresponding tags. These identified trends and/or patterns may further be used to organize and structure the source data as desired. Method 400 may be performed in accordance with the present invention in any of the environments depicted in FIGS. 1-2, among others, in various approaches. Of course, more or less operations than those specifically described in FIG. 4 may be included in method 400, as would be understood by one of skill in the art upon reading the present descriptions.

Each of the steps of the method 400 may be performed by any suitable component of the operating environment using known techniques and/or techniques that would become readily apparent to one skilled in the art upon reading the present disclosure. For example, one or more processors located at a central server of a distributed system (e.g., see processor 212 of FIG. 2 above) may be used to perform one or more of the operations in method 400. In another example, one or more processors located at an edge server (e.g., see controller 217 of FIG. 2 above).

Moreover, in various approaches, the method 400 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As shown, operation 402 involves a user (e.g., researcher) accessing a machine learning mechanism. With respect to the present description, the “mechanism” may include one or more machine learning models that are trained to dynamically analyze source data and generate tagged clusters which cognitively categorize the source data. Moving to operation 404, the machine learning mechanism is made available as a tool that is accessible to the user. For instance, the user may be able to utilize the machine learning mechanism by interacting with a software interface. Operation 406 further includes the user actually electing to apply the machine learning mechanism.

Proceeding to operation 408, background information associated with the source data is collected. Again, analyzing details that describe certain characteristics of the data being evaluated provides valuable insight that allows for inductive tags to continue being generated. It follows that the background information is evaluated using an artificial intelligence (AI) corpus at operation 410, and inductive tags are produced at operation 412. The AI corpus may include any desired number of machine learning models that are configured to evaluate the type and/or amount of background information that is received.

In addition to inductive tags, some approaches implement predetermined tags. Looking now to operation 414, a user may choose to enter one or more predetermined tags. Operation 416 also includes generating one or more suggested tags based on received information. For instance, a topic of the data being evaluated may be used to generate suggested predetermined tags. Operation 418 allows users to enter predetermined tags as desired, e.g., depending on the type of data being evaluated. Furthermore, operation 420 includes customizing the generated tags to appear as desired. Outputs from operations 416, 418, and 420 are merged to generate predefined tags in operation 422.

Method 400 further includes combining outputs of operations 412 and 422 to evaluate data that has been received. See operation 424. From operation 424, method 400 advances to operation 426 where data is produced as a result of evaluating the data at operation 424. From operation 426, method 400 advances to operation 428 which includes using a content clarifier module to evaluate the data and generate a simplified version (e.g., summary) of the data produced at operation 426.

From operation 428, method 400 splits to both operation 430 and operation 432. It follows that operations 430 and 432 may be performed in parallel. Operation 430 includes analyzing a full set of the data (e.g., content), while operation 432 includes evaluating a summarized version (e.g., copy) of the data. The summarized version of the data may be produced by the content clarifier module.

Results of the analysis performed in operations 430 and 432 are further evaluated using machine learning models of an AI corpus at operation 434. Operation 436 includes creating clusters of information in the data, e.g., using information output by the machine learning models. Furthermore, operation 438 includes generating tags for each of the clusters.

Although the tags are generated at operation 438, they are preferably evaluated again before being implemented. Accordingly, operation 440 includes making adjustments to details of the tags generated at operation 438. Operation 442 also includes generating new tags in some situations where supplemental tags are used. Proceeding to operation 444, the modifications to the generated tags are implemented and a resulting set of information may be exported, e.g., as described above.

According to an in-use example, which is in no way intended to limit the invention, a researcher who is interested in understanding enterprise content management may implement one or more of the approaches described herein to categorize and analyze data collected for research study. The user begins by uploading their research plan (e.g., study plan) which includes information about the research objectives, research question(s), research methods, data collection methods, participants, etc., or any other relevant information about the research study.

The user may also select predefined tags that are to be used to categorize the received data. The user is able to select one or more of the predefined tags that have been provided for implementation, and/or create new tags. The user is also able to adjust details corresponding to the tags which will be used to visually distinguish between the different categories of data. For instance, the user may be presented with an opportunity to select colors of the tags, form templates for the tags, determine a total number of tags implemented, etc.

As the user collects data for the research study, the mechanism automatically captures and processes the data in real time. This includes using the content clarifier to simplify the meaning of technical content and separating the data into clusters of information. The mechanism also suggests inductive tags based on the content of the data and the domain of the research, which the user is able to use to further categorize the data. When the research study is completed, the user is able to view the output of the tag analysis. This may include a visual representation of the tags and the data, a summary of the findings, or other information about the data. The user is preferably given an opportunity to edit, modify, re-establish, etc., the tag criteria to make any changes to the tags and/or corresponding clusters.

An export component may further be used to export the different types of tags and the data clusters in a desired format, e.g., such as a .pdf file. As a result, the user will be able to share any results of their research with others and/or to use the data for further analysis.

Again, implementations herein desirably allow users to tag and categorize data in real-time. This is achieved, at least in part, because machine learning models have been trained to identify tags from specific domains. Moreover, users may predetermine specific tags based on the type of data and/or an overarching topic in the data. As a result, implementations can identify different types of tags based on the context from various modalities (e.g., different types of data that are being collected, such as text, audio, video, and/or other types of data). This improvement may be applied to remote mechanisms of communication and/or research, e.g., as would be appreciated by one skilled in the art after reading the present description.

According to another in-use example, which is in no way intended to limit the invention, predefined tags may be established by uploading a study plan or research plan that includes information about how data was originally generated. As noted above, one or more machine learning models may be used to evaluate the data and suggest tags for the data, e.g., given the domain of research (e.g., types of jobs to be done, journey phases, types of users, etc.). Desired ones of the predefined (e.g., predetermined) tags may thereby be selected. The default settings of the predetermined tags (e.g., color, form, etc.) may be maintained in some approaches, while in other approaches the predetermined tags may be modified. In some approaches, new tags may even be generated to replace the predetermined tags.

The tags are preferably processed in real-time. Moreover, users may be able to review the output of the tag analysis. Based on the review, users may be able to edit, modify, or re-establish tag criteria.

According to another in-use example, which is in no way intended to limit the invention, inductive tags may be generated based on supplemental (e.g., background) information corresponding to the received data. In this example, a study plan or research plan is uploaded and evaluated using one or more machine learning models.

Based at least in part on the evaluation, the machine learning models may suggest tags for the data given the domain of research (e.g., types of jobs to be performed, journey phases, types of users, etc.). Predetermined and/or inductive tags may also be evaluated while determining one or more tags for each cluster of information identified in the received data. Some approaches may involve searching for other themes based on keywords, topics, etc. The user is further able to leave default settings or modify colors and/or forms of the tagging performed. A content clarifier may also be used to help simplify the meaning of technical content.

As a result, tags are captured and processed in real-time using the implementations herein. For instance, one or more machine learning models may be used to separate received data into clusters of information, and generates tags for each of the clusters. Moreover, users are able to edit, modify, re-establish, etc. details of the tag, e.g., as described herein.

According to another in-use example, which is again in no way intended to be limiting, a user working on a contextual inquiry may use approaches herein to identify specific desired settings. While conventional analysis of collected information has been time consuming, implementations herein allow the user to analyze incoming data in real-time. For instance, when a patient is talking about pain experienced at a point, machine learning models may be able to suggest tags that correspond to experiencing paint at the point. Visualized findings that triangulate collected data may thereby be generated.

In still another in-use example, a user captures a substantial amount of data from a longitudinal study. The data includes user comments that are analyzed to provide feedback to different developers and designers about features and interactions. Using conventional products and procedures, performing this analysis is taxing. However, by establishing at least some predetermined tags, the user may selectively add tags that are known to be relevant to the data being evaluated. This helps the user simplify the evaluation process and improve operational efficiency. Moreover, the user may be able to provide recommendations in future implementations.

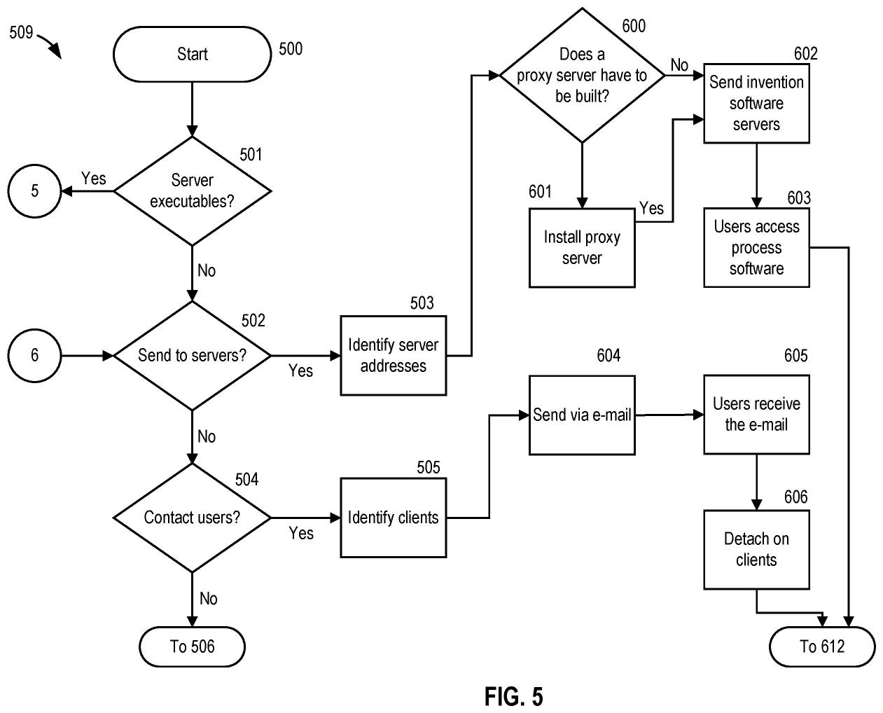

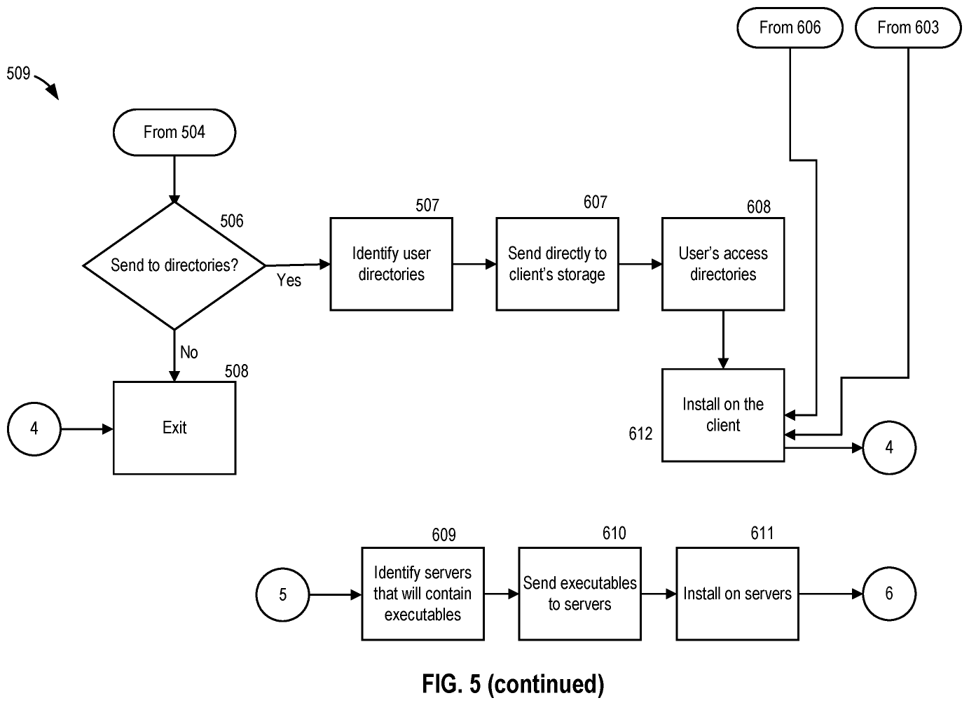

Now referring to FIG. 5, a flowchart of a method 509 is shown according to one embodiment. The method 509 may be performed in accordance with the present invention in any of the environments depicted in FIGS. 1-4, among others, in various embodiments. Of course, more or fewer operations than those specifically described in FIG. 5 may be included in method 509, as would be understood by one of skill in the art upon reading the present descriptions.

Each of the steps of the method 509 may be performed by any suitable component of the operating environment. For example, in various embodiments, the method 509 may be partially or entirely performed by a processing circuit, e.g., such as an IaC access manager, or some other device having one or more processors therein. The processor, e.g., processing circuit(s), chip(s), and/or module(s) implemented in hardware and/or software, and preferably having at least one hardware component, may be utilized in any device to perform one or more steps of the method 509. Illustrative processors include, but are not limited to, a central processing unit (CPU), an application specific integrated circuit (ASIC), a field programmable gate array (FPGA), etc., combinations thereof, or any other suitable computing device known in the art.

While it is understood that the process software associated with analyzing source data as well as dynamically generate clusters and corresponding tags to support cognitive categorization and analysis of the source data may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

With continued reference to method 509, step 500 begins the deployment of the process software. An initial step is to determine if there are any programs that will reside on a server or servers when the process software is executed (501). If this is the case, then the servers that will contain the executables are identified (609). The process software for the server or servers is transferred directly to the servers' storage via FTP or some other protocol or by copying though the use of a shared file system (610). The process software is then installed on the servers (611).

Next, a determination is made on whether the process software is to be deployed by having users access the process software on a server or servers (502). If the users are to access the process software on servers, then the server addresses that will store the process software are identified (503).

A determination is made if a proxy server is to be built (600) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (601). The process software is sent to the (one or more) servers either via a protocol such as FTP, or it is copied directly from the source files to the server files via file sharing (602). Another embodiment involves sending a transaction to the (one or more) servers that contained the process software, and having the server process the transaction and then receive and copy the process software to the server's file system. Once the process software is stored at the servers, the users via their client computers then access the process software on the servers and copy to their client computers file systems (603). Another embodiment is to have the servers automatically copy the process software to each client and then run the installation program for the process software at each client computer. The user executes the program that installs the process software on the client computer (612) and then exits the process (508).

In step 504 a determination is made whether the process software is to be deployed by sending the process software to users via e-mail. The set of users where the process software will be deployed are identified together with the addresses of the user client computers (505). The process software is sent via e-mail (604) to each of the users' client computers. The users then receive the e-mail (605) and then detach the process software from the e-mail to a directory on their client computers (606). The user executes the program that installs the process software on the client computer (612) and then exits the process (508).

Lastly, a determination is made on whether the process software will be sent directly to user directories on their client computers (506). If so, the user directories are identified (507). The process software is transferred directly to the user's client computer directory (607). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (608). The user executes the program that installs the process software on the client computer (612) and then exits the process (508).

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
receiving data and predetermined tags associated with the received data;
summarizing content in the received data;
using a machine learning model to analyze the summarized content and the received data;
dividing the received data into clusters of information;
generating tags for the clusters of information by merging (i) the predetermined tags, and (ii) details produced by the machine learning model; and
outputting the generated tags.

2. The computer-implemented method of claim 1, wherein outputting the generated tags includes:
displaying the generated tags to a user;
receiving modifications to the generated tags from the user;
applying the received modifications to the generated tags; and
exporting the modified tags.

3. The computer-implemented method of claim 2, wherein exporting the modified tags includes:
converting the modified tags into a predetermined exportable format; and
sending the modified tags to a target location.

4. The computer-implemented method of claim 1, comprising:
receiving background information corresponding to the received data; and
using the machine learning model to:
analyze the received background information, and
generate inductive tags based at least in part on the analysis.

5. The computer-implemented method of claim 4, wherein generating tags for the clusters of information includes merging (i) the predetermined tags, (ii) the details produced by the machine learning model, and (iii) the inductive tags.

6. The computer-implemented method of claim 1, wherein summarizing content in the received data includes:
sending one or more instructions to a content clarifier module to evaluate the received data and dynamically simplify the content in the received data; and
receiving the summarized content from the content clarifier module.

7. The computer-implemented method of claim 1, wherein the generated tags are of a type selected from the group consisting of: journey tags, workflow tags, and sentiment tags.

8. The computer-implemented method of claim 1, wherein the received data includes one or more types of information selected from the group consisting of:
video recordings, audio recordings, and screen recordings.

9. The computer-implemented method of claim 1, wherein the machine learning model is configured to perform natural language processing and/or classification machine learning.

10. A computer program product, comprising a computer readable storage medium having program instructions embodied therewith, the program instructions readable by a processor, executable by the processor, or readable and executable by the processor, to cause the processor to:
receive data and predetermined tags associated with the received data;
summarize content in the received data;
use a machine learning model to analyze the summarized content and the received data;
divide the received data into clusters of information;
generate tags for the clusters of information by merging (i) the predetermined tags, and (ii) details produced by the machine learning model; and
output the generated tags.

11. The computer program product of claim 10, wherein outputting the generated tags includes:
displaying the generated tags to a user;
receiving modifications to the generated tags from the user;
applying the received modifications to the generated tags; and
exporting the modified tags.

12. The computer program product of claim 11, wherein exporting the modified tags includes:
converting the modified tags into a predetermined exportable format; and
sending the modified tags to a target location.

13. The computer program product of claim 10, wherein the program instructions are readable and/or executable by the processor to cause the processor to:
receive background information corresponding to the received data; and
use the machine learning model to:
analyze the received background information, and
generate inductive tags based at least in part on the analysis.

14. The computer program product of claim 13, wherein generating tags for the clusters of information includes merging (i) the predetermined tags, (ii) the details produced by the machine learning model, and (iii) the inductive tags.

15. The computer program product of claim 10, wherein summarizing content in the received data includes:
sending one or more instructions to a content clarifier module to evaluate the received data and dynamically simplify the content in the received data; and
receiving the summarized content from the content clarifier module.

16. The computer program product of claim 10, wherein the generated tags are of a type selected from the group consisting of: journey tags, workflow tags, and sentiment tags.

17. The computer program product of claim 10, wherein the received data includes one or more types of information selected from the group consisting of: video recordings, audio recordings, and screen recordings.

18. The computer program product of claim 10, wherein the machine learning model is configured to perform natural language processing and/or classification machine learning.

19. A system, comprising:
a processor; and
logic integrated with the processor, executable by the processor, or integrated with and executable by the processor, the logic being configured to:
receive data and predetermined tags associated with the received data;
summarize content in the received data;
use a machine learning model to analyze the summarized content and the received data;
divide the received data into clusters of information;
generate tags for the clusters of information by merging (i) the predetermined tags, and (ii) details produced by the machine learning model; and
output the generated tags.

20. The system of claim 19, wherein outputting the generated tags includes:
displaying the generated tags to a user,
receiving modifications to the generated tags from the user;
applying the received modifications to the generated tags;
converting the modified tags into a predetermined exportable format; and
sending the modified tags to a target location.
